(19) United States
(12) Patent Application Publication
(10) Pub. No.: US 2008/0018560 A1
(43) Pub. Date: Jan. 24, 2008

(54) Method Of Addressing A Plasma Display Panel

(76) Inventor: Vladimir Nagorny, San Jose, CA (US)

Correspondence Address: Vladimir NAGORNY, 1272 Tulloch Drive, Tracy, CA, 95304, US

(21) Appl. No.: 11/577,279

(22) PCT Filed: Jun. 1, 2006
(86) PCT No.: PCT/US06/21210

§ 371 Date: Apr. 13, 2007

Related U.S. Application Data
(60) Provisional application No. 60/700,720, filed on Jul. 20, 2005.
(60) Provisional application No. 60/767,223, filed on Mar. 13, 2006.

(51) Int. Cl. G09G 3/28

(52) U.S. Cl. 345/60

(57) ABSTRACT

A novel addressing technique, aimed at reduced addressing time of a PDP panel is disclosed in the present invention. The invention uses new scanning voltage waveform, new voltage waveforms for bulk sustain and data electrodes, as well as discharges in all the pixels (both ON and OFF), which allows to significantly lower the voltage controlled by address drivers. Although elements of this technique can be used in any panel and in conjunction with many other methods of shortening the address period, the effectiveness of this technique depends on the geometrical parameters of a PDP cell.

### TECHNICAL FIELD

This invention relates to a method of fast addressing of a full color AC plasma display panel, that allows one to use an increased number of subfields (in one picture field), and respectively to have better image quality, and/or to use a single-scan driving scheme even for a full high definition panel (1080 and more lines), and/or increase brightness since significantly more time will be left for sustaining.

### BACKGROUND ART

Plasma display (or gas discharge) panels (PDPs) are well known in the art and, in general, comprise a structure including a pair of substrates (101 and 105) supporting column and row electrodes respectively, each coated with a dielectric layer, as shown in FIG. 1. The distance between substrates is defined by the height of the vertical barrier ribs (13), separating red, green and blue columns. Horizontal electrodes usually form sustain pairs (sometimes one uses split electrodes), each pair of sustain electrodes X (108B) and Y (108A) defines a cell. Sometimes one uses additional barriers (waffle structure) that separate cells of the same color. The discharge can be continuously “sustained” by applying an alternating sustain voltage (which, by itself, is insufficient to initiate a discharge) to sustain X and Y electrodes. The technique relies upon wall charges generated on the dielectric layers of the substrates which, in conjunction with the sustain voltage, operate to maintain continuing discharges. Usually all X electrodes are connected to a single bus wire, so they are called “bus” or “bulk” electrodes, and Y electrodes, each connected to individual drivers called “scan” electrodes.

In more details, the operation of AC cell is based on a cell's capability to hold a wall charge after the previous discharge. If one initially placed a large charge on the cell's walls so that in the absence of external voltage the conditions in the cell are close to, but below the breakdown conditions, and then applies to the cell the external voltage that doubles the electric field in the cell, then a strong pulse discharge occurs. This discharge results in another wall charge distribution which compensates the external field, and thus is close to the initial wall distribution, but distributed in the opposite direction with respect to the sustain electrodes of a given cell (see FIG. 1). Every time the external voltage alternates, the discharge conditions in the cell change, so that the wall charge and external voltage together are able to initiate another strong discharge, and so on. On the other hand, if there was no charge on the walls initially, or if the wall charge distribution inside the cell is such that at any time one does not meet conditions for the discharge, then this cell would not exhibit any discharge activity.

### DISCLOSURE OF INVENTION

### Technical Problem

The addressing speed is critical for the operation, quality, and cost of the PDP, especially for high definition displays. Indeed, for 60 Hz operation, the total time available for displaying a full color image is 16.67 ms. To display all colors (8 bit or 256 grey levels for each color) one has to have at least 8 subfields, where each subfield has a relative brightness (number of sustain pulses) proportional to 2^{N}−1, where N is a subfield's number. In order to eliminate the motion picture distortions, one uses different, less optimized bit-wise scheme, which has at least 10 rather than 8 sub-fields. It is obvious that the more time one spends for addressing, the less time is left for actual sustaining, and if addressing of one subfield (with resetting) took more than 1.67 ms, then no time would be left for sustaining, since every subfield requires resetting and addressing. With about 1000 lines to address (780 lines for HDTV, 1080 lines—for full HDTV) the addressing time of just 1.5 us per row will take almost all the time available for displaying. In this case to address the panel within the required time one has to use a double scan scheme (when the screen is divided into two parts, each one has its own address electrodes), which is much more expensive, because it requires twice as many address drivers, and special aligning. But even with a double scan when using the current addressing schemes, the time left for actual sustaining is still too low for a high quality full HDTV panel. To keep the panel bright enough companies use interlacing, complex algorithms and different addressing schemes which often results in new artifacts. While newer panels do not have moving distortions that older 8-subfield panels had, the quality of a static image of new HD and especially Full HD panels are often worse than that of older ones with a lower number of subfields. So, if one could reliably address a line in less than 1 us, it would make single scan addressing possible for a full HDTV PDP without introducing new image distortions.

Independently of the specifics of a particular addressing scheme every one of them uses the effect of the wall charge memory. In order to place a memory charge in selected cells, quite a few schemes have been proposed. The most popular of them, which provides reliable addressing and contrast necessary for high quality panel is the ADS (Address Display Separated) scheme (U.S. Pat. No. 5,541,618, No. 5,724,054, No. 5,745,086, No. 5,446,344, No. 6,956,331, etc.), where the addressing and sustaining of the panel are separated. It has however some flaws that we describe below.

There are basically two schemes for ADS addressing. To keep higher contrast (a “must” for high quality displays) one turns the selected cells ON, and nothing is applied to the OFF cells. The disadvantage of this method is a large addressing time (˜1.5-2 us per row). So to address the entire high definition panel one has to use double scan addressing (one for the upper half, and the other for the lower half of the display), which requires twice as many address drivers and very precise aligning. In the other version one first turns ALL cells ON (which takes about 2-5 us for the whole panel), and then selectively turns some of them OFF in a way described above (sequentially row by row, with selective addressing in each row). Since it takes less time to turn the cell OFF than to turn it ON, this scheme allows one to address the row in about 1 us. The disadvantage of this method is a low dynamic range and a contrast ratio that is un-acceptable for high quality TV, since even dark cells experience at least one strong discharge in addition to the setup discharge per every subfield. Some versions of the ADS scheme use additional measures to speed up the addressing (priming pulses and/or additional electrodes),—they ALL fit the same scheme: “unlock the row-->selective address ON (or OFF)-->lock the row-->go to the next row”.

FIG. 2 shows the basic realization of the common ADS scheme using a ramp setup with a negative going ramp at the end. During the reset period every cell of a panel is set to a specific OFF condition, when wall charges together with applied voltages result in voltages V_{XY} and V_{AY} in the discharge gaps between X and Y and A and Y electrodes close to the breakdown ones, and the panel is ready to be addressed. For convenience we will use the magnitudes of the applied voltages (V_{X}, V_{Y}, V_{A}) in the end of the second ramp as a reference point to which all other voltages are added, when describing any addressing scheme. After the second negative ramp a positive voltage (V_{lock}), “locking” the wall charges and blocking every cell from the possibility of being addressed is applied to all scan (Y) electrodes. The sign of the locking voltage V_{lock} is always chosen to be opposite to the direction of the last ramp to make both V_{XY} and V_{AY} below the breakdown ones, even when one applies address voltage V_{ON}. During the addressing period the scan pulse unlocks every row one by one by removing the locking voltage from the appropriate Yₙ scan electrode, where n is the row number. While the line is unlocked it can be addressed and when the voltage V_{ON} is applied to the selected (ON) data column electrodes, the addressed cells experience strong discharges, which change the wall charge distribution, leaving the memory charges. After being addressed, the row is locked again, and the same procedure is applied to the next row. The time required for addressing the row (and keeping the line unlocked) is determined by how fast the discharge grows and decays. If one tried to lock the line back right after the discharge has occurred but before plasma density has significantly decayed, it may change a memory charge, or even cause a secondary discharge, erasing it. This obviously limits the possibility for shortening the address time, since it can not be shorter than the minimum scan time, T_{scan,min}. Thus the shortest addressing time T_{addr} in conventional schemes is equal to T_{scan,min}: T_{addr}>=T_{scan,min}, as shown in FIG. 3.

FIG. 3 schematically shows the part of the address period, when two rows n and n′ are addressed consecutively. One can see that the OFF cell does not experience discharge activity at any time, and that before addressing the next line (row) one locks the current one back again. The correct addressing is achieved by a large enough locking voltage and by choosing the addressing time T_{addr} long enough for the density of charged particles in the cell addressed ON to decay. The plots of currents I (dotted lines) and charge particles densities N (solid lines) in intersections (n, k), (n, k′), etc. shown in FIG. 3, reflect that densities decay much slower than currents.

### Technical Solution

An object of the present invention is to shorten the time necessary for addressing the panel. Another object is to reduce the voltage controlled by the address drivers, which strongly affects the cost of the panel. The present invention exploits the possibility of having addressing discharges in more than one row simultaneously, thus achieving the high speed of addressing of the whole panel rather than of a single line. As will be explained below, in order to realize this scheme, one has to use two level (ON and OFF) addressing, with a fast OFF discharge, which imposes some restrictions on geometric parameters of the PDP cell. However, the version of the two-level and “one-line-at-a-time” addressing scheme can be used with more common geometrical parameters resulting in low voltage addressing, and/or higher speed.

Description of the New Scheme

A plasma panel, incorporating the invention, includes circuitry for applying row signals sequentially to a plurality of row electrodes. Each row signal includes a set-up period, address period and sustain period. The set-up period creates standardized wall potentials at each pixel site along each row electrode. Address circuitry applies, during the address period, data pulses to a plurality of column electrodes to enable selective discharge of the pixel sites in accordance with data pulses and in synchronism with the row signals. The new addressing technique utilizes addressing with discharges in both ON and OFF cells, by initiating different discharge modes for ON and OFF cells, so that ON cells experience a strong write discharge pulse, and the OFF cells—a much weaker erase discharge. This new scheme does not necessarily use or require the locking of the line after addressing it and its ultimate realization can be described as “unlock the line-->selective addressing with discharges in both ON and OFF cells-->go to the next line”, which is shown in the FIGS. 4a, 4b. In this ultimate realization, in fact, cells that are addressed ON may still have a large plasma density when the next row is being addressed (see FIG. 5).

In the end of the setup period (see FIG. 4a), as in conventional addressing scheme, a large positive voltage V_{lock} is applied to all scan electrodes preventing, any discharge activity in the locked rows. In the new scheme, however, another pair of voltages is applied at the beginning and for the duration of the address period: 1) the positive bias voltage V_{OFF} initiating OFF discharges between data and scan electrodes, when the voltage V_{lock} is removed (V_{scan}=−V_{lock} is applied to selected line) is applied between all data column and sustain (both X and Y) electrodes, and 2) the negative voltage V_{Xlock}, blocking discharges initiated by the bias voltage V_{OFF}, from expanding to the bulk X electrode, is applied to the bulk X electrodes, as shown in FIG. 4a. Obviously there are many ways how voltages V_{OFF} and V_{Xlock} can be applied. For example, one can apply bias V_{OFF} to all data electrodes or negative voltage “−V_{OFF}” to all sustain electrodes (Xs and Ys) as in FIG. 4b—the result will be the same, as long as the differences between potentials applied to the electrodes are the same. So, for convenience of the explanation we will use V_{OFF} as if it is applied to data electrodes, and focus explanation on the ultimate realization first.

At the selected moment the scan voltage removing “the lock” from selected row is applied to the selected scan electrode to allow addressing of the appropriate row. Data voltages Vaddr (on top of previously applied voltage V_{OFF}) are applied to selected ON cells, so the total addressing voltage applied to the ON cells is V_{ON}=V_{OFF}+V_{addr}, and to the OFF ones is V_{OFF}. After the weak discharge in the OFF cell is ended the negative scan voltage can be applied to the next line and the next selected row is being addressed, even if the plasma density in the ON cell is still large. The scan electrode stays unlocked as the addressing moves to the next line—it may stay constant up to the end of the whole addressing period (as in FIGS. 4a, 4b), or for a limited time (as in FIGS. 4c, 4d) but it should stay unlocked for no less than T_{scan, min}, so that plasma in the ON cell has time to decay.

The cells, that are addressed OFF may experience up to two weak ERASING discharges—one when this particular line is being addressed, and another one when later on a cell of the same column, is addressed ON, as shown in the FIG. 5.

Locking the row back is advantageous if due to geometrical parameters of the cell one can not complete the OFF discharge faster than Tscan, min. In this case the new addressing scheme follows the structure “unlock the row-->selective address with discharges in both ON and OFF cells-->lock the row-->go to the next row” (as in FIG. 4e) addressing time is T_{addr}=T_{scan,min} and the advantage of new technique is the possibility of using lower voltage data drivers, since they have to control only the voltage V_{addr}=V_{ON}−V_{OFF} rather than V_{ON}. The choice of specific realization of the driving scheme depends on geometric parameters of the cell.

The magnitude of V_{Xlock} voltage depends on the geometrical parameters of the cell.

When the cell has large separation between X and Y sustain electrodes (Sustain Gap) and small Plate Gap, so that there are no electric field lines connecting the X and Y electrodes without crossing the dielectric on the opposite wall this voltage may be zero or even positive.

“Next” row or line in the description of the new scheme means “next in sequence” rather than the adjacent row. It fact, it may be the most advantageous to use a row sequence similar to dual or triple scan sequences: (1, N/2+1, 2, N/2+2, 3, N/2+3, . . . ) or (1, N/3+1, 2N/3+1, 2, N/3+2, 2N/3+2, 3, N/3+3, 2N/3+3, . . . ), where N is the total number of rows controlled by a particular scan driver.

Analysis of the Present Invention

In order to understand the underlying principle of the new method, one has to understand how the process of addressing of a three electrode system actually works, and what limits its speed. At the end of the reset period (using for example ramp setup U.S. Pat. No. 5,745,086, and our presentation at the SID'2000, Digest of SID'00, pp. 114-117) in the prior schemes (FIG. 2) the wall charges combined with external voltages applied to a cell, produce conditions inside the cell which are very close to those required for the discharge breakdowns both between the scan and address electrodes (Y-A), and between scan and bulk sustain electrodes (Y-X). In other words voltages, V_{AY} and V_{XY} are close to breakdown ones. When during the address period the scan voltage is applied to a scan electrode, it brings the cell to the same condition as it was at the end of the reset period, thus unlocking it. So, when one applies a positive voltage to the address electrode, it initiates Y-A discharge between address and scan electrodes (Plate-Gap Discharge). Since this voltage is usually not so large, and due to the structure of the electric field, this discharge by itself does not produce a large memory charge on the dielectric over the scan electrode. The primary function of the Plate-Gap Discharge, though, is to initiate a strong X-Y Sustain-Gap Discharge between the scan Y and the bulk X sustain electrodes, which transfers a large charge between them. This discharge between the X and Y electrodes is the one responsible for the memory charge necessary for further sustaining of the cell. After the Sustain-Gap Discharge, a high density plasma produced by it stays in the cell well after the current has decayed. If one tries to lock the line back again and changes the voltage applied to the scan electrode too early, while the plasma density is still high, it may result in decreasing or even erasing the memory charge. To shorten the address time one usually increases the amplitude of the address voltage and shortens the gap between X and Y electrodes in order to accelerate initiation of the Sustain-Gap discharge, or also applies an additional voltage between the X and Y electrodes (U.S. Pat. No. 6,525,486 B2 “Method and device for driving an AC type PDP” by K. Awamoto, et. al).

Our investigations have shown that while one cannot change the voltage of the scan electrode until the plasma density has decayed, one can safely change or even completely remove (ground) the voltage applied to the address electrode immediately after the peak of the Sustain-Gap discharge (or later). In fact, the memory charge may even increase. FIGS. 6a and 6b show the current through the electrodes during a regular address discharge and similar discharge, but with the voltage applied to address electrode experiencing 70V drop to zero in the very peak of the Sustain-Gap discharge. As we have suggested, the memory charge increased (by 2%). So, if one started addressing the next row (unlocking it and applying appropriate address voltages) without locking the current one back (as in FIGS. 4a, 4b, 5), it would not affect in a negative way the memory charge of the current row cells addressed ON. It may, however, produce an undesirable ON discharge in the OFF cell that was previously not addressed, which would result in misaddressing. In order to avoid such misaddressing the new scheme uses an additional erasing discharge in the cell that is supposed to be OFF (see FIGS. 4a, 4b, 5). This discharge employs a weak Plate-Gap discharge that transfers enough charge across the Plate-Gap, to make misaddressing impossible for that cell later on when the higher ON voltage may be applied to the same data electrode. To make sure that the weak OFF discharge would not initiate the Sustain-Gap discharge, one may have to suppress penetration of this discharge toward the X electrode, by applying a voltage to the bulk sustain X electrodes (V_{Xlock} in FIGS. 4a-4d) lowering the voltage between X and Y sustain electrodes.

This method allows one to choose the time for addressing the line between the time required to finish the OFF discharge (as shown in FIG. 5), and the time to finish the ON discharge and use the smaller of two. In the latter case one has to lock the line again before addressing the next one. As we have already mentioned the relationship between these times depend on the geometric relation between plate and sustain gaps (between data and scan and between scan and bulk sustain electrodes).

The advantages of the proposed scheme come in one of three ways: 1) If the parameters of a PDP cell allow one to achieve a fast OFF discharge (T_{OFF}<T_{scan, min}) then, one can use the ultimate scheme and have address (ON) discharges in more than one line simultaneously; 2) If one cannot achieve fast OFF discharge (T_{OFF}>T_{scan, min}), then one can either use a lower voltage for the address drivers (V_{addr}=V_{ON}−V_{OFF}) or 3) achieve a higher speed for the ON discharge (and shorter T_{addr} by combining conventional address drivers with V_{OFF} bias.

Compared to existing addressing schemes, which are all designed to ease the initiation of the Sustain-Gap discharge, and sometimes even increase the voltage between the X and Y electrodes (as in U.S. Pat. No. 6,525,486 B2, quoted above) this scheme actually uses the opposite—the obstruction of such premature initiation (V_{Xlock} in FIGS. 4a-4c has the appropriate sign) in order to achieve as high as possible amplitude of V_{OFF}, if the “simultaneous initialization point” (SIP) relates to Plate Gap and Sustain Gap discharges. Only if at the end of the ramp SIP relates to two Plate Gap discharges (XA and AY), typical for geometries with large sustain gap and small plate gap (which currently are not used, but may be used in the future), than V_{Xlock} should be zero or may even be positive—in such a geometry the weak plate gap discharge does not spread to the second (X) sustain electrode.

A high value of V_{OFF} lowers the operational voltage for address drivers (see below) and makes the plate gap discharge faster. In order to have the memory charge in the ON cell as high as with conventional driving, the voltage applied to X electrodes during the ramp is higher, than in conventional schemes, so that after applying V_{Xlock} to it, it is still as high as or higher than in conventional schemes. Ideally, the initiation of the Sustain-Gap discharge in the new scheme occurs only if and when the voltage VON is high enough to start a strong rather than weak Plate—Gap discharge. In this case, high density plasma fills the gap above the scan electrode, which results in reconfiguration of electric field lines, and fast development of the Sustain-Gap discharge.

Since it takes only a few extra Volts across the gap to change conditions from weak to strong discharge, the difference between VON (strong discharge) and VOFF (weak discharge) can be small (10-20V). While the magnitude of V_{ON} may be large, the actual addressing voltage (V_{addr}) controlled by address drivers is only V_{ON}—V_{OFF} (as seen on FIGS. 4a-4c, 5), since the constant bias voltage V_{OFF} is applied to all data electrodes (or “−V_{OFF}” to all sustain electrodes) for the duration of the address period. The terms “weak” and “strong” discharge have the same meaning as in our publications in Journal of Applied Physics, Vol. 77, pp. 3645-3656. (1995), and in Journal of Applied Physics, Vol. 94, pp. 6291-6302 (2003). “Weak”—designates a discharge where the ion density is relatively low, it does not compensate the electric field anywhere in the volume; the electron density in the volume is much lower than the ion density and the change to the electric field comes mostly from the charge deposited on the walls rather than from the space charge. “Strong”—designates a discharge where a high density plasma (with the electron density close to ion density) is being created at least in some region, and space charge significantly affects the electric field in the gap.

Although the proposed scheme can be applied to every PDP cell, its effectiveness and simplicity may depend on geometrical parameters of a PDP cell. For example it may not be as effective (speed-wise) in a cell with a large plate gap and narrow sustain gap. However, if the plate gap in the vicinity of the sustain electrodes is small and sustain gap is large it has significant advantage over currently existing addressing schemes, since the speed of the OFF discharge (inverse time) depends on the plate gap size L as 1/L². Our 3-D kinetic simulations of the address discharge in the cell with the plate gap of 70 um and sustain gap of 260 um showed that using the proposed scheme one can easily achieve T_{addr} of only 650-800 ns, with V_{addr} of only about 10-20 V (Voltages used in simulations: V_{OFF}˜40-50V, and V_{ON}=60V). FIG. 7a shows OFF discharge currents in that cell when V_{OFF}=50V was applied to the cell—the discharge ended in less than 700 ns, and there was no discharge activity between sustain electrodes. On the other hand when V_{ON}=60V (V_{add}=10V) was applied to the cell, the strong discharge connecting sustain electrodes (see FIG. 7b) appeared in less than 330 ns.

Although the practice of this invention is described herein with each pixel or sub-pixel defined by a three-electrode surface discharge structure, this invention may also be used with surface discharge structures having more than three distinct electrodes, for example more than two distinct electrodes on the top substrate and/or more than one distinct electrode on the bottom substrate. In the literature, some surface discharge structures have been described with four or more electrodes including three or more electrodes on the front substrate.

Both the Y row scan and the X bulk sustain electrodes may be of a transparent material such as tin oxide or indium tin oxide (ITO) with a conductive thin strip, ribbon or bus bar along one edge. Split or divided electrodes connected by cross-overs may also be used for X, Y and column data electrodes. The electrode arrays on either substrate are shown in FIG. 1 as orthogonal, but may be of any suitable pattern including zig-zag or serpentine.

The prior art has also described surface discharge structures where there is a sharing of electrodes between pixels or sub-pixels on the front substrate. Fujitsu has described this structure in a paper by Kanazawa et al published on pages 154 to 157 of the 1999 Digest of the Society for Information Display. Fujitsu calls this “Alternating Lighting on Surfaces” or ALIS. Fujitsu has used ALIS with ADS. Shared electrodes may be used is the practice of the present invention.

The prior art has also described a counter-electrode PDP structure where the sustain electrodes (both scan and bulk) are facing each other and placed not on the front plate, but rather between front and back plates. This structure is described in the Proceedings of the SID' 2005 Conference (H. Asai, et al., “Discharge characteristics of a new structure AC-PDP using Thick Film Ceramic Sheet technology” Digest of SID'05, pp. 210-213, 2005), and in the Proc. of the IDW 2003 Conference (H. Asai, et al., “Development of new Structure AC-PDP using Thick Film Ceramic Sheet Technology”, IDW'03, pp. 401-406, 2003). The present invention can be used in this kind of structure.

The prior art has also described the ramp setup with only one ramp designed in such a way that it results in positive wall charges on the surface near sustain electrodes, and negative charges on the dielectric surface near the address electrode (J. -G. Bae, J. -Y. Kim, “New driving method for AC PDPs employing new ramp reset”, Digest of SID'05, pp. 610-613, 2005). In their case the addressing required opposite polarity—positive scan pulse, and negative data pulse. The present invention can be used in this kind of setup, and only the polarity of applied voltages has to be adjusted.

### Advantageous Effects

The advantages of the proposed scheme come in one of three ways: 1) If the parameters of a PDP cell allow one to achieve a fast OFF discharge (T_{OFF}<T_{scan, min}) then, one can use the ultimate scheme and have address (ON) discharges in more than one line simultaneously; 2) If one cannot achieve fast OFF discharge (T_{OFF}>T_{scan, min}), then the scan time is limited to T_{scan,min} and one can either use a lower voltage for the address drivers (V_{addr}=V_{ON}−V_{OFF}) or 3) achieve a higher speed for the ON discharge (and shorter T_{addr}) by combining conventional address drivers with V_{OFF} bias.

### DESCRIPTION OF DRAWINGS

FIG. 1. Prior Art: Basic AC gas discharge plasma display panel cell with a surface discharge structure. The cell 100 has a bottom or rear glass substrate 101 with column data (address) electrodes 102, barrier ribs 103, and phosphors 104R, 104G, 104B, which radiate red (104R), green (104G) and blue (104B) light when excited by UV photons from the discharge. The front substrate 105 is transparent glass for viewing and contains Y row scan (or sustain) electrodes 108A and X bulk sustain electrodes 108B, dielectric layer 106 covering the electrodes 108A and 108B, and a thin layer 107 of magnesium oxide or other special material on the surface of dielectric 106. The magnesium oxide layer is used to enhance secondary electron emission and electron exoemission and helps to lower the overall operating voltage of the display. Two substrates 101 and 105 are sealed together, and the gas mixture fills the plurality of channels 109 formed by the barrier ribs 103. This is typically a mixture of the rare gases.

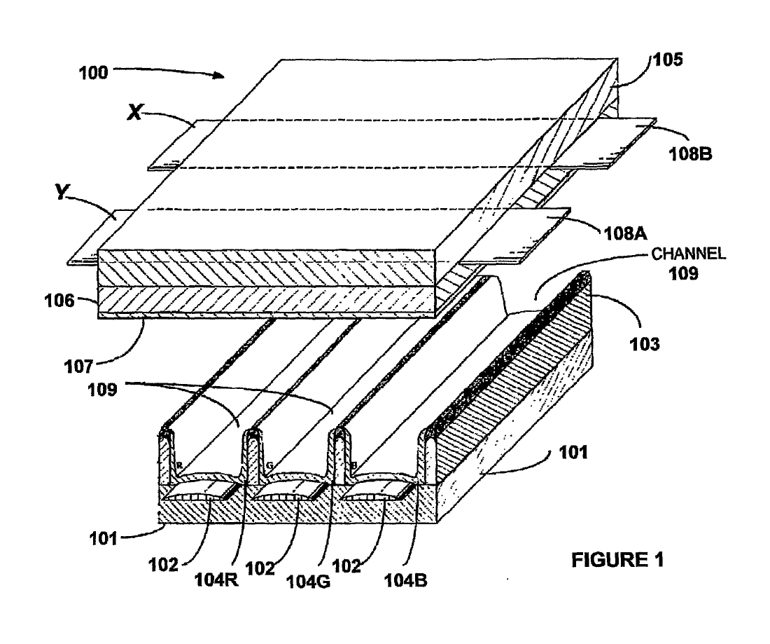

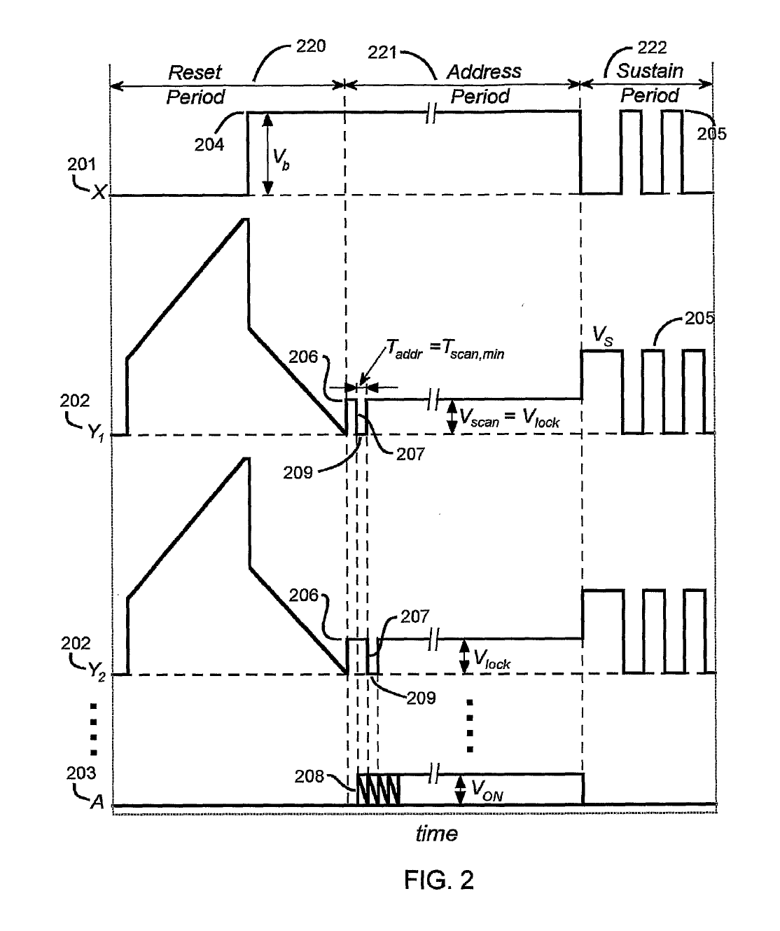

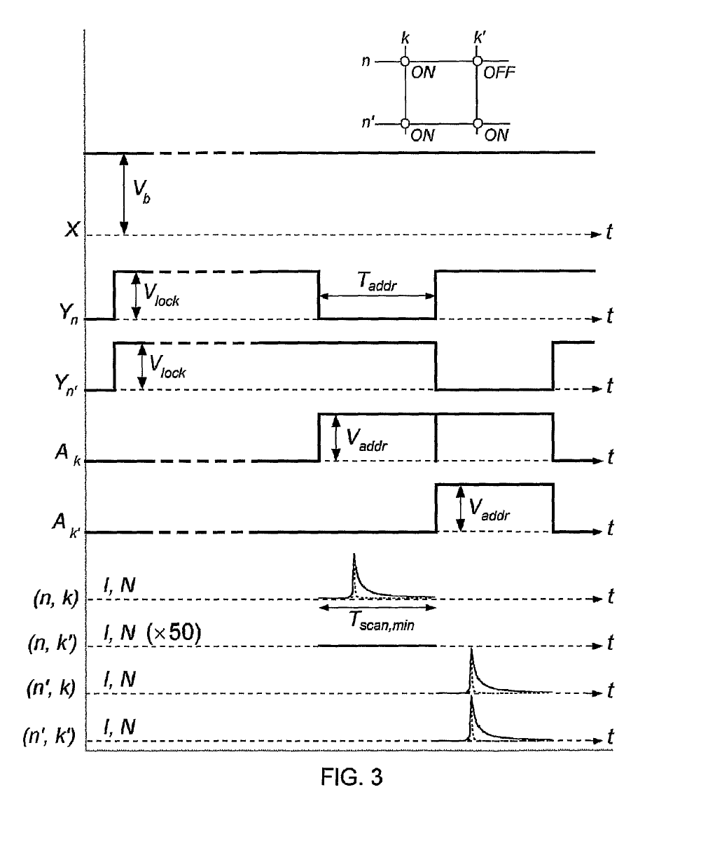

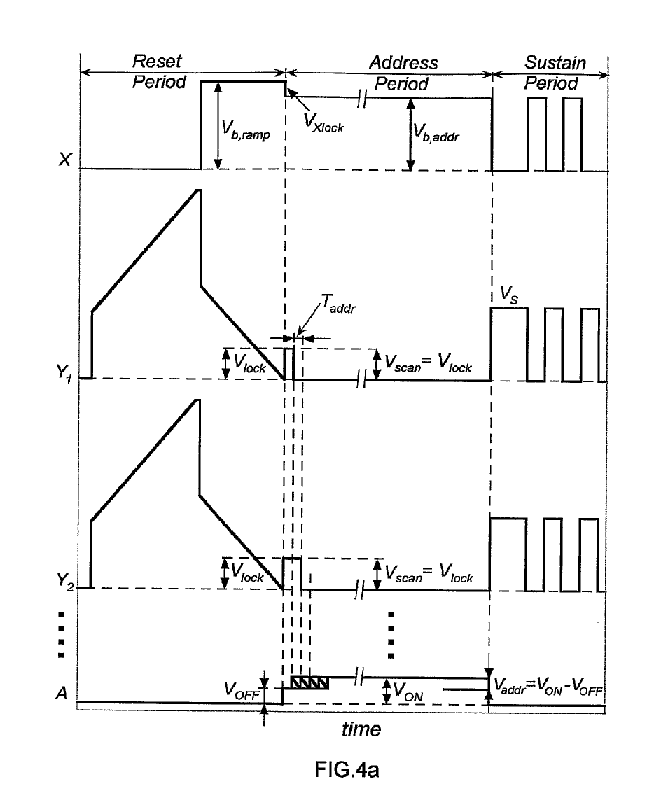

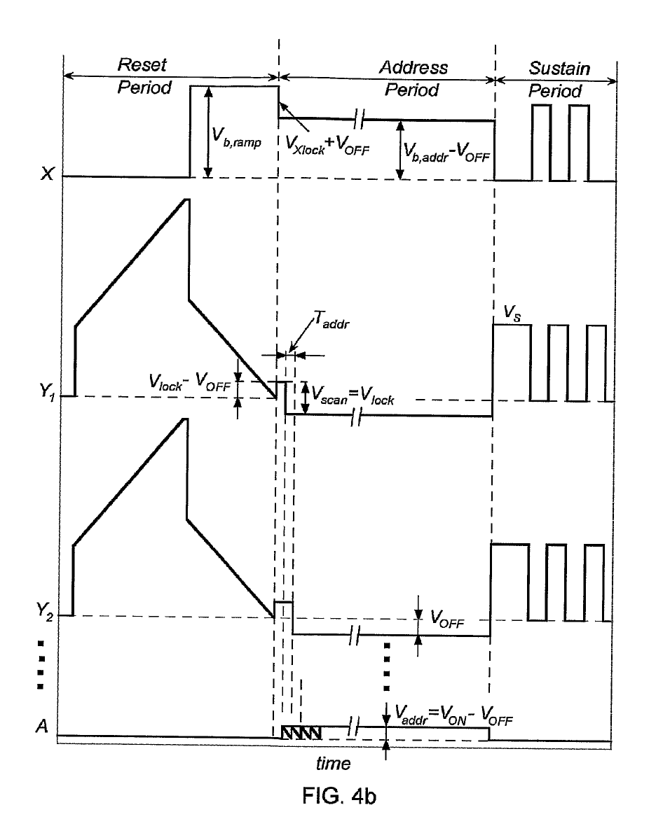

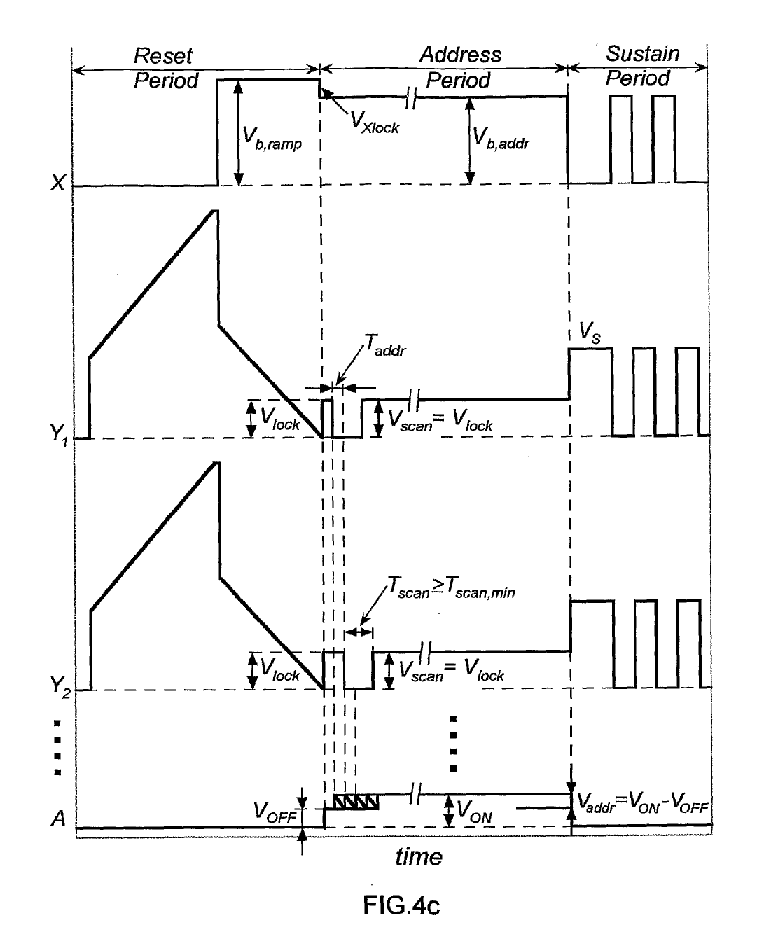

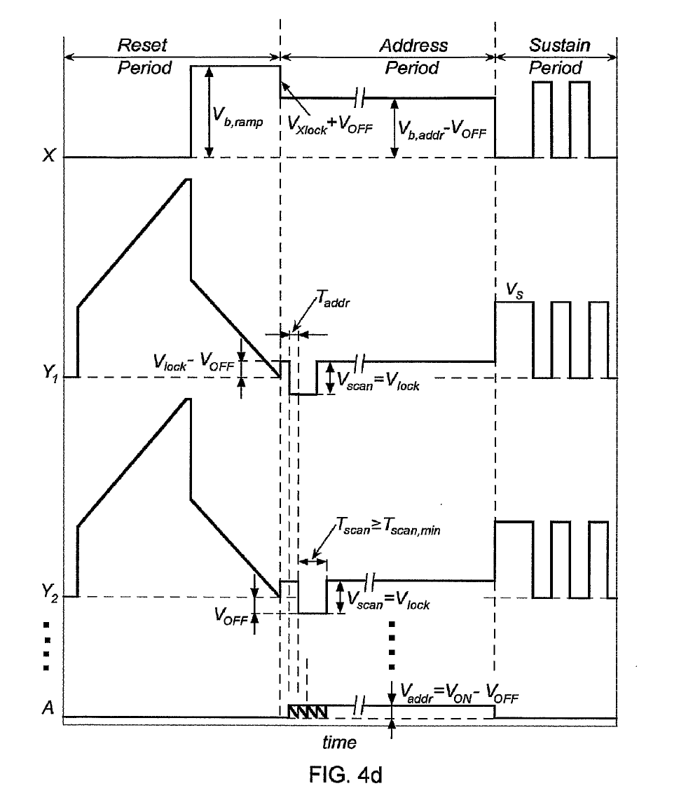

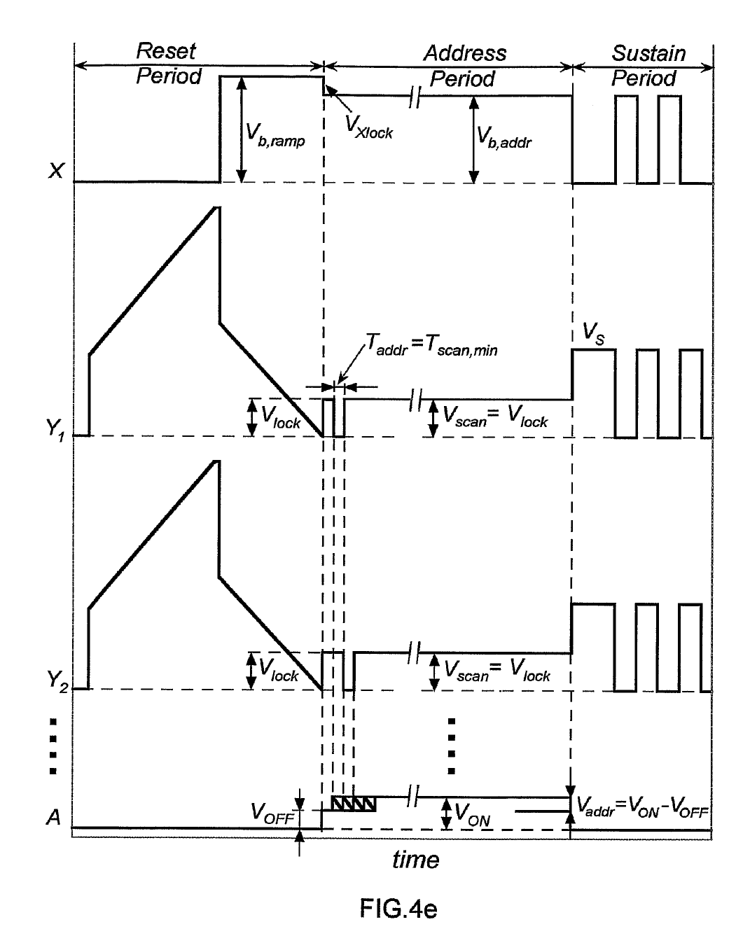

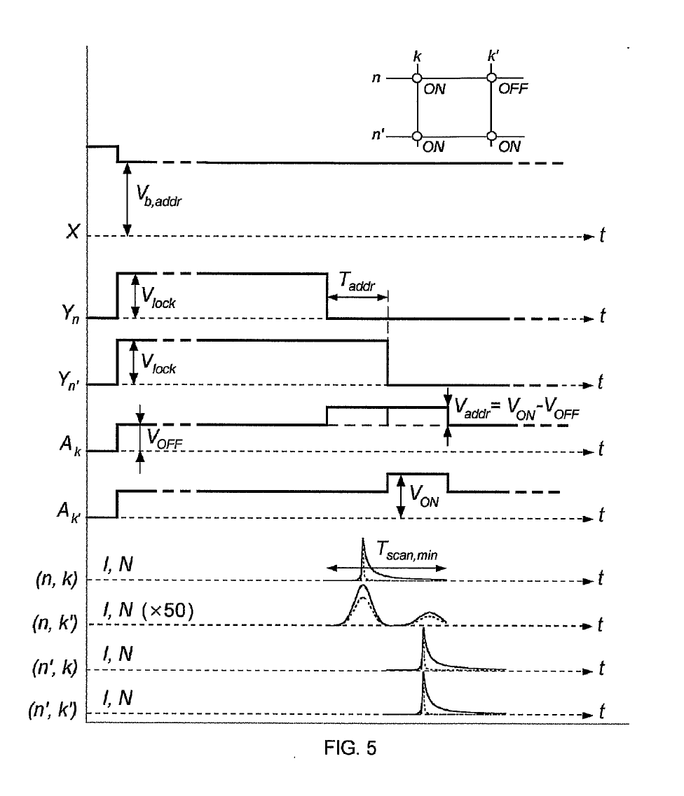

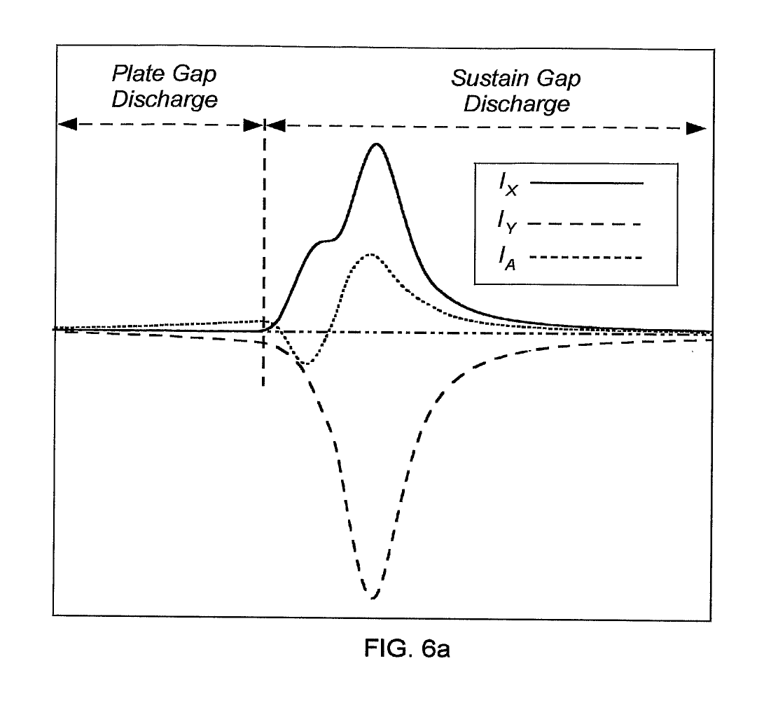

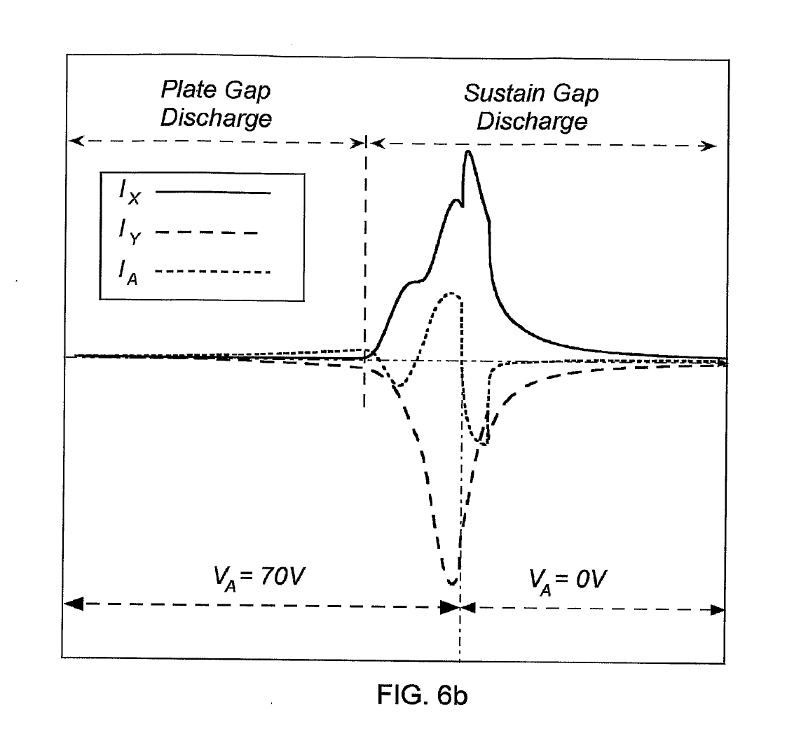

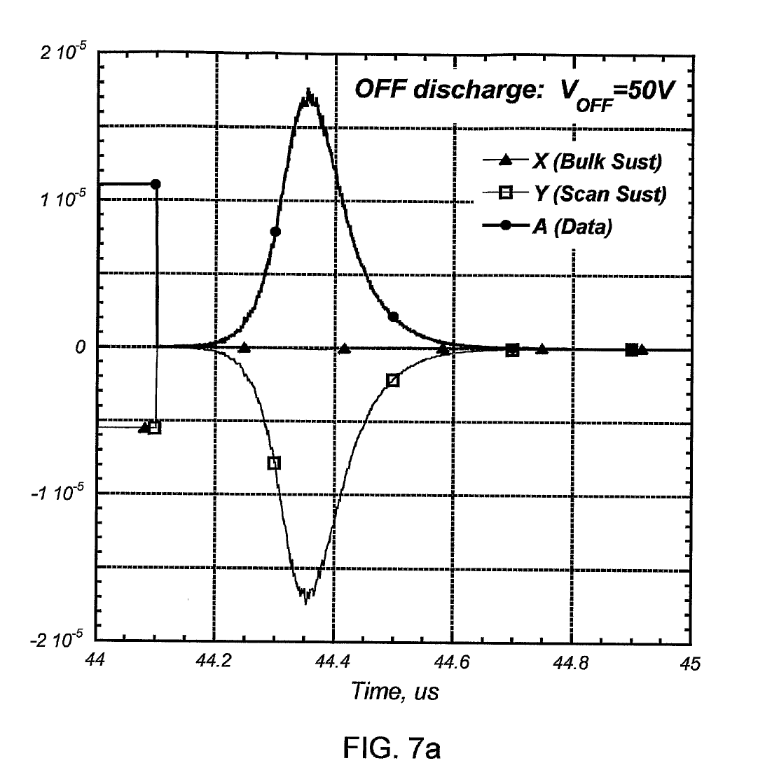

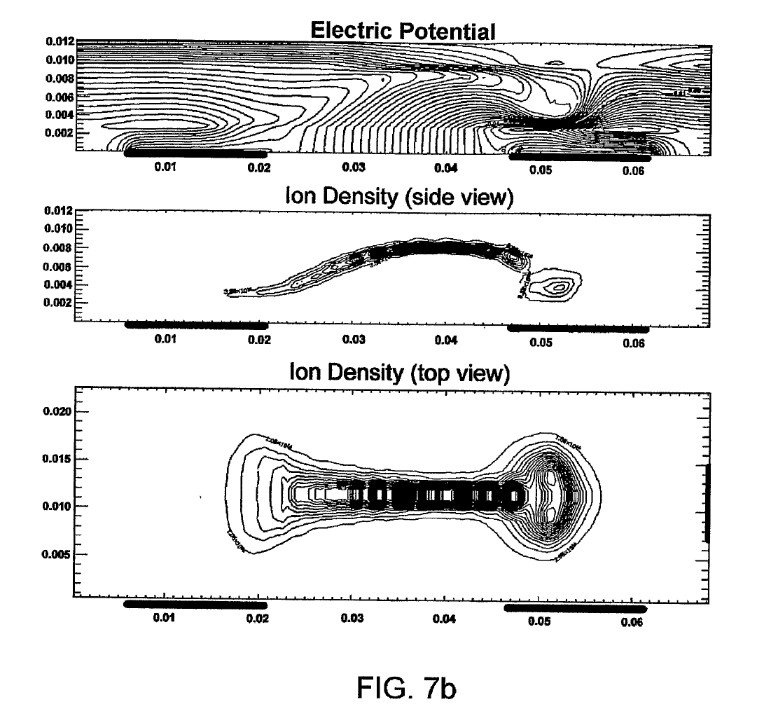

A pixel or sub-pixel is defined by the three electrodes 102, 108A, and 108B. Distance between inner edges of sustain electrodes 108A and 108B is called Sustain Gap. Distance between the phosphor on the bottom of the channel 109 of the back plate and magnesium oxide 107 on the front plate is called the Plate Gap. The address discharge is initiated by voltages applied between a bottom column data electrode 102 and a top Y row scan electrode 108A. The sustain discharge is done between pair of the front Y row scan electrode 108A and a top X bulk sustain electrode 108B. Each pair of the Y and X electrodes is a row.

FIG. 2. Prior Art: Conventional ADS driving of AC PDP with ramp reset. Every subfield has reset (220), address (221) and sustain (222) periods. During about half of the reset period all bulk sustain (X) electrodes (201) are kept at zero potential, while all scan (Y ) sustain electrodes (202) are ramped UP. During the second half of the reset period when all scan electrodes 202 (Y) are ramped down, high positive voltage (204) V_{b} (usually close to the sustain voltage (205) Vₛ) is applied to all bulk sustain (X) electrodes (201). Data (A ) electrodes (203) stay grounded for the whole reset period. Parameters of the reset ramps are chosen in such a way that at the end of it steady discharge currents are flowing between scan electrodes and two other electrodes in every cell, so that the breakdown conditions are satisfied between both pairs Y-X and Y-A. When the positive voltage V_{lock} (206) is applied to scan electrodes, all discharges are interrupted, all voltages are significantly below than the breakdown ones and charged particles leave the volume. During the address period the negative scan pulse 207 (|V_{scan}|=V_{lock}) unlocks the selected row, and address voltage V_{ON} (208) is applied to selected columns (zero to the rest). It is essential that when the scan voltage is applied to Y electrode, it unlocks both pairs Y-X and Y-A, easing the initiation of the Sustain-Gap discharge. The speed of addressing depends on the data voltage VON.

FIG. 3. Prior Art: Detail of address period and explanation of work. Figure shows that large amplitude of V_{lock}, prevents any discharge activity in the cell when it is locked independently on whether VON is applied to A electrode or not. The scan pulse must be long enough for the charge density in the cell to decay.

FIG. 4a. New Art: New driving waveform (realization—version 1). Reset period in new driving scheme is the same as in FIG. 2, except that during the second half of the ramp reset period when scan electrodes (Y) are being ramped down, the voltage applied to bulk sustain electrodes Vb,ramp may be higher than in a common scheme. In the end of the reset period voltages V_{lock}, V_{Xlock} and V_{OFF} are applied to Y-scan, X-bulk sustain and data column electrodes respectively. When addressing the line the negative scan-pulse (|V_{scan}|=V_{lock}) unlocks the selected row, and address voltage V_{addr}=V_{ON}−V_{OFF} is applied to selected columns on top of V_{OFF}. Besides unlocking the line the scan voltage initiates discharges in OFF cells, in a way “addressing” them. Due to the voltage V_{Xlock} applied to X electrode, the OFF discharge does not initiate the Sustain-Gap discharge. The speed of addressing depends on the voltage V_{OFF} and dimensions of the Plate Gap. Line stays unlocked until the end of the addressing period.

FIG. 4b. New Art: New driving waveform (realization—version 2). The same as in FIG. 4a, except that instead of applying the voltage V_{OFF} to data column electrodes, one applies “−V_{OFF} ” to all sustain electrodes. One can use any combination of cases shown in FIGS. 4a and 4b.

FIG. 4c. New Art: New driving waveform (realization—version 3). Same as in FIG. 4a, except that the line stays unlocked for a limited time T>T_{scan, min}.

FIG. 4d. New Art: New driving waveform (realization—version 4). Same as in FIG. 4b, except that the line stays unlocked for a limited time T>T_{scan, min}.

FIG. 4e. New Art: New driving waveform (realization for T>T_{scan, min}). Same as in FIG. 4a, except that the line stays unlocked for T=T_{addr}, which in this case is equal to

FIG. 5. New Art—Detail of address voltage and explanation of work. Large amplitude of V_{lock}, prevents any discharge activity in the cell when it is locked. Voltage V_{OFF} is applied to all data (A) electrodes. The scan voltage initiates weak discharges in OFF cells and provides conditions for addressing ON cells with low voltage V_{addr}=V_{ON}−V_{OFF}. When discharge in the OFF cell is finished the next row is being addressed. Depending on the amplitudes of V_{OFF} and V_{ON} the second current pulse may be initiated in the OFF cell. Coefficient (50) for the current in the OFF cell is shown only for demonstration of the difference in magnitude of these currents/densities, and has no quantitative value.

FIG. 6a. Effect of the variation of the address voltage during the ON discharge (conventional addressing). Typical address discharge in a PDP cell with close Sustain Gap, with V_{A}=70V.

FIG. 6b. Effect of the variation of the address voltage during the ON discharge (conventional addressing). Same discharge as in FIG. 6a, but in the peak of it the data voltage changed from 70V to 0V. Memory charge is practically the same as in the case shown in the FIG. 6a (actually larger by 2%).

FIG. 7a. Result of 3-D kinetic simulations of the address OFF discharge in the cell with the plate gap of 70 um and sustain gap of 260 um. Figure shows currents through electrodes in that cell. With only V_{OFF}=50V applied, the Plate Gap discharge ends in less than 700ns, and there is no discharge activity between sustain electrodes.

FIG. 7b. Result of 3-D kinetic simulations of the address ON discharge in the same cell. When V_{ON}=60V (V_{addr}=10V) was applied to the cell, the strong discharge connecting sustain electrodes developed in less than 330 ns. Figures show distribution of the electric potential in the mid-plane crossing the channel in the middle (bottom and top substrates are in the bottom and top of the figure), ion density in the same plane, and average ion density if one looks at the cell from the front plate through scan electrodes. Thick lines in the bottom of each plot and on the side of the last one indicate position of electrodes.

### BEST MODE

The most benefits come from the possibility to have as high as possible V_{OFF} and short Plate Gap, since the speed of the OFF discharge (inverse time) depends on the plate gap size L as 1/L², and proportional to V_{OFF}. Large V_{OFF} provides additional benefit of having lower voltage controlled by address drivers, which affects the cost of the panel.

### MODE FOR INVENTION

We tested (numerically) different plasma display cells. In the cells with large Plate Gap (105-130 um) and short Sustain Gap (−80 um) the main advantage was the possibility of the high voltage (40-70V) of the OFF discharge, thus making possible low data voltage (only 20-30V) and fast addressing. The best results were obtained when using cell with large Sustain gap (260 um) and short Plate gap (70 um), where we obtained T_{addr} of only 650-800 ns, with Vaddr of only about 10-20V (voltages used in simulations: V_{OFF}40-50V, and V_{ON}=60V).

### INDUSTRIAL APPLICABILITY

The method has industrial applicability for plasma displays.

1. A method for driving an AC plasma display panel to provide a low voltage and/or high speed addressing, said plasma panel containing plural discharge sites (cells) arranged in rows and columns, with each row containing at least one pair of electrodes and each column containing at least one electrode, and further containing circuit means for applying drive signals to said electrodes during setup (reset), address and display (sustain) periods, said method utilizes discharges in both ON and OFF cells initiated by appropriate drive signals during the address period and comprises of steps: equalizing wall charge conditions in all cells prior to addressing using a ramp setup, locking these conditions and preventing any discharge activity in the panel by applying voltage V_{lock} to all scan electrodes at the end of the reset period, applying the bias voltage V_{OFF} smaller than V_{lock} between all data and all sustain electrodes (both X and Y), to initiate discharges in OFF cells when the scan pulse unlocks the row for addressing, and applying additional address voltage V_{addr} to selected data electrodes for initiating ON discharges in selected cells.

2. A method of addressing an AC plasma display panel as recited in claim 1, wherein the voltage V_{OFF} between all data electrodes and all sustain electrodes is applied for the whole address period.

3. A method of addressing an AC plasma display panel as recited in claim 2, wherein additional voltage V_{Xlock} is applied to bulk sustain electrodes for the length of the address period, where the polarity of the V_{Xlock} is chosen to be opposite to the V_{lock} polarity.

4. A method of addressing an AC gas discharge plasma display panel as recited in claim 1, wherein drive signals initiate different modes of the discharge (weak and strong) for addressing ON and OFF cells in the addressed row, where weak mode is initiated by the bias voltage V_{OFF} applied non-selectively between all data electrodes and all sustain electrodes, and the strong discharge is initiated by additional voltage V_{addr} applied selectively to the data electrodes of selected ON cells, said voltage V_{addr} is enough to switch the discharge mode.

5. A method of addressing an AC plasma display panel as recited in claim 4, wherein the scan voltage once applied to a row selected for addressing continues to be applied to it when the scan drive voltage unlocks the next row for addressing, thus realizing the sequence of actions: 1) “unlock the row”, 2) “address both ON and OFF cells”, and 3) “go to the next row” without locking the addressed row back prior to addressing the next one; the row may stay unlocked by the scan voltage up until the end of the address period, and the time between application of the scan voltage to two sequential rows is determined by the time necessary to complete the OFF discharge, and to start the discharge between sustain electrodes in the ON cells.

6. A method for driving an AC plasma display panel to provide a low voltage and/or high speed addressing, said plasma panel containing plural discharge sites (cells) arranged in rows and columns, with each row containing at least one pair of electrodes and each column containing at least one electrode, and further containing circuit means by which to apply drive signals to said electrodes during setup (reset), address and display (sustain) periods, said method utilizes discharges in both ON and OFF cells initiated by appropriate drive signals during the address period, where OFF discharges are initiated by applying the bias voltage V_{OFF} between all data and all sustain electrodes (both scan and bulk) and ON discharges are initiated by applying additional address voltage Vaddr to selected data electrodes.

7. A method of addressing an AC gas discharge plasma display panel as recited in claim 6, wherein drive signals initiate different modes of the discharge (weak and strong) for addressing ON and OFF cells in the addressed row, non-selectively applying voltage V_{OFF} between all data electrodes and all sustain electrodes, and selectively addressing the ON cells, using the voltage necessary to switch one mode of the discharge to another.

8. A method of addressing an AC plasma display panel as recited in claim 6, wherein the voltage V_{OFF} between all data electrodes and all sustain electrodes is applied for the whole address period.

9. A method of addressing an AC plasma display panel as recited in claim 7, wherein the scan voltage once applied to a row selected for addressing continues to be applied to it when the scan drive voltage unlocks the next row for addressing, thus realizing the sequence of actions: 1) “unlock the row”, 2) “address both ON and OFF cells”, and 3) “go to the next row” without locking the addressed row back prior to addressing the next one; the row may stay unlocked by the scan voltage up until the end of the address period, and the time between application of the scan voltage to two sequential rows is determined by the time necessary to complete the OFF discharge, and to start the discharge between sustain electrodes in the ON cells.

10. An AC gas discharge plasma display panel, comprising plural discharge sites (cells), arranged in rows and columns, with each row containing at least one pair of electrodes separated from the discharge site by a dielectric layer and each column containing at least one electrode separated from the discharge site by layers of dielectric and possibly phosphor, said plasma panel further comprises circuit means for applying drive signals to a plurality of said electrodes during setup (reset), address and display (sustain) periods; said drive signals initiate discharges in both ON and OFF cells during selective addressing, where OFF discharges are being initiated by applying the bias voltage V_{OFF} between all data and all sustain electrodes (both scan and bulk) and ON discharges are initiated by applying an additional address voltage V addr to selected data electrodes.

11. The AC plasma panel as recited in claim 10, utilizing different discharge modes for selective addressing of ON and OFF cells in the addressed row, applying non-selectively voltage V_{OFF} between all data electrodes and all sustain electrodes to initiate a weak discharge mode and selectively applying additional voltage V_{addr} to ON cells, said voltage Vaddr is large enough to switch the weak mode of the discharge to a strong one.

12. The AC plasma panel as recited in claim 11, wherein the voltage V_{OFF} between all data electrodes and all sustain electrodes is applied for the duration of the address period.

13. The AC plasma panel as recited in claim 12, wherein a locking voltage is applied to all scan electrodes before or in the beginning of the address period, and a scan voltage is applied to a scan electrode of the addressed row both initiates discharges in the OFF cells and enables select addressing of the ON cells of that addressed row.

14. The AC plasma panel as recited in claim 13, wherein the scan voltage once applied to a row for addressing stays applied to it when the scan drive voltage unlocks for addressing the next row, thus realizing the sequence of actions: 1) “unlock the row”, 2) “address both ON and OFF cells”, and 3) “go to the next row” without locking the addressed row back prior to addressing the next one;
the scan voltage may stay applied up to the end of the address period, and the time between application of the scan voltage to two sequential rows is determined by the time necessary to complete the OFF discharge.

15. The AC plasma panel as recited in claim 13, with row electrodes placed on the front substrate, and column data electrodes placed on the back substrate.

16. The AC plasma panel as recited in claim 14, with row electrodes placed on the front substrate, and column data electrodes placed on the back substrate.

17. The AC plasma panel as recited in claim 10, wherein in the end of the reset period or in the beginning of the address period a locking voltage V_{lock} preventing any cell from being addressed is applied to all scan electrodes, then for the duration of the address period a pair of voltages are applied: 1) voltage bias V_{OFF} between all data and all sustain electrodes, where |V_{OFF}| must be smaller than |V_{lock}| and 2) voltage V_{Xlock} to all bulk (X) electrodes to obstruct propagation of the OFF discharge between sustain electrodes when the scan pulse removing V_{lock} is applied to the scan electrode of the addressed row, or to accelerate its propagation if the OFF discharge is faster than the ON discharge.
